(19) United States
(12) Patent Application Publication
(10) Pub. No.: US 2024/0062158 A1
(43) Pub. Date: Feb. 22, 2024

(54) INFORMATION PROCESSING APPARATUS, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Takehito WATANABE, Kanagawa (JP)

(73) Assignee: FUJIFILM Business Innovation Corp., Tokyo (JP)

(21) Appl. No.: 18/179,425

(22) Filed: Mar. 7, 2023

(30) Foreign Application Priority Data
Aug. 22, 2022 (JP) 2022-132096

(51) Int. Cl. G06Q 10/10; G06N 20/00

(52) U.S. Cl. CPC G06Q 10/103; G06N 20/00

(57) ABSTRACT

An information processing apparatus includes a processor configured to: extract a feature quantity regarding one or more ongoing projects; input the feature quantity extracted from the one or more ongoing projects to a prediction model, to predict a project that is to have a final outcome of failure among the one or more ongoing projects, the prediction model having been subjected to machine learning using, as teaching data, a feature quantity of a past project having a final outcome of failure and the final outcome of failure; and give a warning for the project predicted to have a final outcome of failure.

### CROSS-REFERENCE TO RELATED APPLICATIONS

This application is based on and claims priority under 35 USC 119 from Japanese Patent Application No. 2022-132096 filed Aug. 22, 2022.

### BACKGROUND

### (i) Technical Field

The present disclosure relates to an information processing apparatus, an information processing method, and a non-transitory computer readable medium.

### (ii) Related Art

Japanese Patent No. 5225027 discloses a computer system that learns the degree of risk from responses to a questionnaire and predicts a project having a high degree of risk.

Japanese Patent No. 6870242 discloses a conference support system that receives voices of participants of a conference, calculates an evaluation value of evaluating a project on the basis of a time during which statements are made in the conference and a time during which the conference is held, and evaluates whether the project is a success or a failure.

### SUMMARY

Aspects of non-limiting embodiments of the present disclosure relate to an information processing apparatus, an information processing method, and a non-transitory computer readable medium that enable additional measures to be taken before a final outcome is obtained for a project that is likely to end with a final outcome of failure.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus comprising a processor configured to: extract a feature quantity regarding one or more ongoing projects; input the feature quantity extracted from the one or more ongoing projects to a prediction model, to predict a project that is to have a final outcome of failure among the one or more ongoing projects, the prediction model having been subjected to machine learning using, as teaching data, a feature quantity of a past project having a final outcome of failure and the final outcome of failure; and give a warning for the project predicted to have a final outcome of failure.

### BRIEF DESCRIPTION OF THE DRAWINGS

An exemplary embodiment of the present disclosure will be described in detail based on the following figures, wherein:

FIG. 1 is a diagram illustrating the configuration of a project management system according to the exemplary embodiment of the present disclosure;

FIG. 2 is a block diagram illustrating the hardware configuration of a project management server according to the exemplary embodiment of the present disclosure;

FIG. 3 is a block diagram illustrating the functional configuration of the project management server according to the exemplary embodiment of the present disclosure;

FIG. 4 is a flowchart illustrating an operation of performing machine learning of a prediction model in the project management server according to the exemplary embodiment of the present disclosure;

FIG. 5 is a flowchart for describing an operation of performing a prediction process by the prediction model generated;

FIG. 6 is a diagram for describing a prediction example in which the prediction model predicts a final outcome from a feature quantity of a project;

FIG. 7 is a diagram illustrating an example of a display screen displayed by a control unit on the screen of a terminal apparatus of a superior;

FIG. 8 is a diagram illustrating an example of a warning screen displayed by operating a warning on the display screen in FIG. 7;

FIG. 9 is a diagram illustrating an example of data stored in a feature quantity storage unit;

FIG. 10 is a diagram illustrating changes with time of a prediction result in a project;

FIG. 11 is a diagram for describing a state in which the control unit executes machine learning of a learning model by using, as teaching data, obtained measures together with feature quantities, prediction results, and information on the dates and times on which the feature quantities are extracted; and

FIG. 12 is a diagram illustrating an example of an operation of obtaining a plan of additional measures by using the learning model.

### DETAILED DESCRIPTION

An exemplary embodiment of the present disclosure will be described in detail with reference to the drawings.

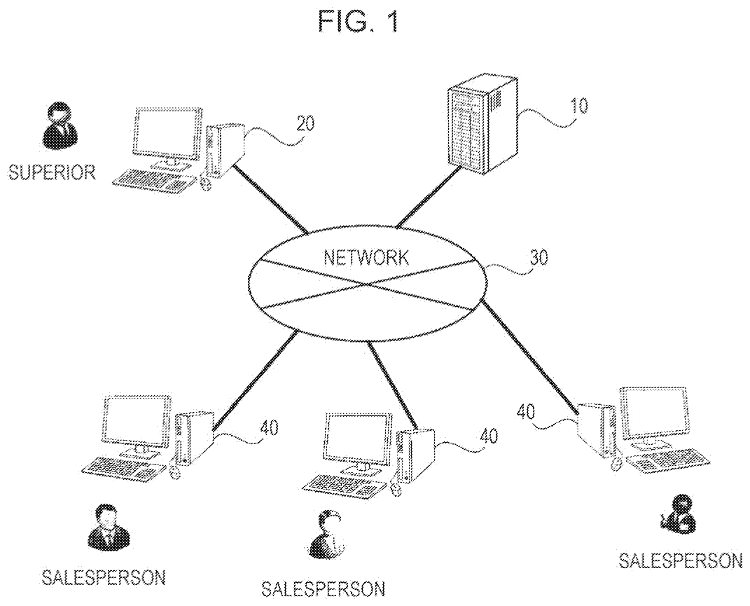

FIG. 1 is a diagram illustrating the configuration of a project management system according to the exemplary embodiment of the present disclosure.

As illustrated in FIG. 1, the project management system according to the exemplary embodiment of the present disclosure includes a project management server 10 and terminal apparatuses 20 and 40, which are connected to each other via a network 30. The project management server 10 is an information processing apparatus that manages projects executed in the past and ongoing projects.

Here, a project means a task implemented to achieve a certain purpose by a set deadline. Examples of the project include a development project of developing a certain software system or products, a sales project for receiving an order for certain items, and a planning project of proposing a certain plan and obtaining an approval.

These various projects end with a final outcome of success in some cases, and end with a final outcome of failure in other cases. For example, in a project of developing a software program within a certain period, a final outcome is a failure if the software program is not completed within the certain period. Even if the software program is completed within the certain period, a final outcome may be a failure if required specifications are not fulfilled or if the product quality is low.

In the present exemplary embodiment, a description will be given of, as an example, a sales project in which plural salespersons perform various activities to receive orders for certain items under a superior. In this sales project, the salespersons perform sales activities by using the respective terminal apparatuses 40. Each salesperson transmits and receives messages and information to and from another salesperson or an external user by using various communication tools, such as email and business support software including a web meeting system, in the terminal apparatus 40. Each salesperson records, in the project management server 10 via the terminal apparatus 40, details of sales activities and the latest status of the project. The superior is able to access the project management server 10 via the terminal apparatus 20 and manage the progress or the current status of the sales project.

If the superior determines that the current status of the project is not very good, he/she instructs the salespersons to take some additional measures to bring the project to success. However, the superior is not necessarily able to constantly be aware of a change in the status of the project and provide an appropriate instruction to take additional measures. Thus, the project management server 10 according to the present exemplary embodiment performs the following processing so that additional measures can be taken before a final outcome is obtained for a project that is likely to end with a final outcome of failure.

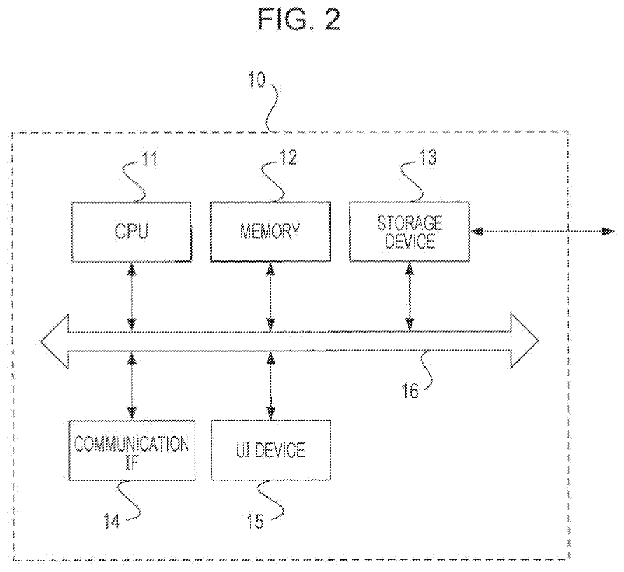

FIG. 2 illustrates the hardware configuration of the project management server 10 in the project management system according to the present exemplary embodiment.

As illustrated in FIG. 2, the project management server 10 includes a central processing unit (CPU) 11, a memory 12, a storage device 13 such as a hard disk drive, a communication interface (IF) 14 that transmits and receives data to and from an external apparatus or the like via the network 30, and a user interface (UI) device 15 including a touch screen or a liquid crystal display and a keyboard. These elements are connected to each other via a control bus 16.

The CPU 11 is a processor that executes predetermined processing on the basis of a control program stored in the memory 12 or the storage device 13 and controls the operation of the project management server 10. In the present exemplary embodiment, the CPU 11 reads out and executes the control program stored in the memory 12 or the storage device 13, but the present disclosure is not limited thereto. The control program may be provided in the form of being recorded on a computer-readable recording medium. For example, the control program may be provided in the form of being recorded on an optical disc, such as a compact disc-read only memory (CD-ROM) or a digital versatile disc (DVD)-ROM, or in the form of being recorded on a semiconductor memory, such as a universal serial bus (USB) memory or a memory card. Alternatively, the control program may be obtained from an external apparatus via a communication line connected to the communication IF 14.

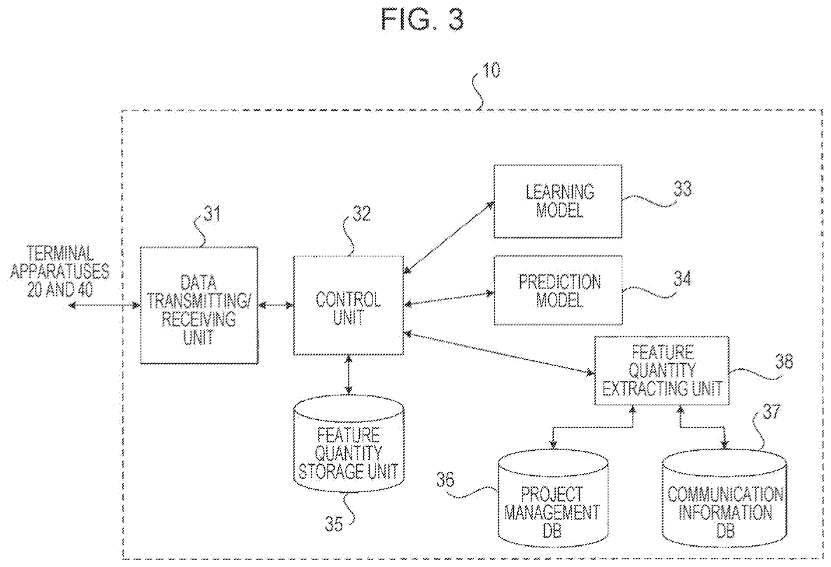

FIG. 3 is a block diagram illustrating the functional configuration of the project management server 10 implemented by the control program being executed.

As illustrated in FIG. 3, the project management server 10 according to the present exemplary embodiment includes a data transmitting/receiving unit 31, a control unit 32, a learning model 33, a prediction model 34, a feature quantity storage unit 35, a project management database (DB) 36, a communication information DB 37, and a feature quantity extracting unit 38.

The data transmitting/receiving unit 31 transmits and receives data to and from an external apparatus including the terminal apparatuses 20 and 40.

The control unit 32 registers, in the project management DB 36, information regarding a project received from an external apparatus including the terminal apparatuses 20 and 40 via the data transmitting/receiving unit 31, and registers, in the communication information DB 37, communication information transmitted and received via various communication tools. Communication information is message information, for example, “This is a material used for an explanation given to the client on a date/month. People in X division participated.”

The control unit 32 also performs processing of transmitting and receiving data to and from an external apparatus including the terminal apparatuses 20 and 40 via the data transmitting/receiving unit 31 and displaying information regarding, for example, the current status of a managed project, on the external apparatus including the terminal apparatuses 20 and 40.

For example, the control unit 32 obtains, from message information transmitted and received in business support software for performing communication between plural users, information on measures taken to implement a project, information on an action performed by a user to implement the project, or information on a medium such as a material that has been used, and stores the obtained information in the project management DB 36 and the communication information DB 37.

The feature quantity extracting unit 38 extracts, from various pieces of information regarding projects registered in the project management DB 36 and the communication information DB 37, feature quantities regarding a past project and an ongoing project.

Specifically, the feature quantity extracting unit 38 extracts, as a feature quantity regarding a project, at least one of information on measures taken to implement the project, information on an action performed by a user to implement the project, information on a medium such as a material that has been used, information on a user participating in the project, or information on business support software that is being used.

Here, information on an action performed by a user to implement the project is, for example, information indicating “I have heard an issue from the client” or information indicating “I have given the client an explanation using a material”. Information on a medium such as a material that has been used is, for example, information indicating that the material used to give an explanation to the client is “proposal material A” or “proposal material B”. In addition, information indicating a start time and an end time of a user action may be used as a feature quantity of the project.

The control unit 32 performs in advance machine learning using, as teaching data, a feature quantity of a past project having a final outcome of failure and the final outcome of failure, thereby generating the prediction model 34. The prediction model 34 is configured to predict, in response to receipt of a feature quantity of a project, whether the final outcome of an ongoing project is a failure or a success.

The control unit 32 may perform machine learning of the prediction model 34 by using, as teaching data, not only a feature quantity of a past project having a final outcome of failure but also a feature quantity of a past project having a final outcome of success and the final outcome of success.

The control unit 32 inputs feature quantities extracted from ongoing projects to the generated prediction model 34, thereby predicting a project that is to have a final outcome of failure among the ongoing projects. The control unit 32 then gives a warning for the project that is predicted to fail.

For example, when the superior displays a screen regarding a project via the terminal apparatus 20, a warning is displayed on the screen to notify the superior that the project is highly likely to fail if there is no change.

In addition, the control unit 32 stores in the feature quantity storage unit 35, in time series, measures taken to implement a project, a prediction result of the prediction model 34 for the project that is ongoing, and a feature quantity of the project obtained when the prediction result is obtained.

In a case where the prediction result stored in the feature quantity storage unit 35 changes from failure to success, the control unit 32 obtains a feature quantity obtained when the prediction result of failure is obtained, and measures taken while the prediction result changes from failure to success.

The control unit 32 performs in advance machine learning using, as teaching data, the feature quantity obtained when the prediction result of failure is obtained, and the measures taken while the prediction result changes from failure to success, thereby generating the learning model 33.

The control unit 32 inputs, to the learning model 33, a feature quantity extracted from the ongoing project for which a warning indicating that the final outcome is predicted to be a failure has been given, thereby obtaining a plan of additional measures for the ongoing project for which the warning has been given.

The control unit 32 then presents the obtained plan of additional measures together with the warning for the project that is predicted to fail.

The control unit 32 may perform machine learning of the learning model 33 by using, as teaching data, not only the feature quantity obtained when the prediction result of failure is obtained but also the feature quantity obtained when the prediction result of success is obtained before the date and time on which the prediction result of failure is obtained.

The control unit 32 determines, based on a condition set in advance, whether a project completed in the past is a failure or a success. For example, in a sales project for receiving an order for a certain item, the control unit 32 determines that the final outcome is a success if an order for the item is received, and determines that the final outcome is a failure if an order for the item is not received.

Next, the operation of the project management server 10 according to the present exemplary embodiment will be described in detail with reference to the drawings.

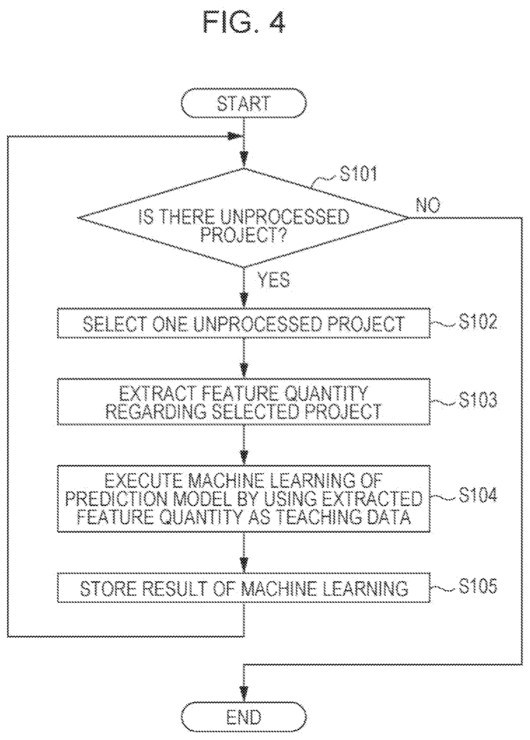

First, an operation performed when machine learning of the prediction model 34 is performed will be described with reference to the flowchart in FIG. 4.

In step S101, the control unit 32 determines whether there is an unprocessed project among projects having a final outcome of failure among past projects having a final outcome.

If there is an unprocessed project, the control unit 32 selects one unprocessed project in step S102. In step S103, the control unit 32 instructs the feature quantity extracting unit 38 to extract a feature quantity regarding the selected project.

In step S104, the control unit 32 executes machine learning of the prediction model 34 by using, as teaching data, the feature quantity extracted by the feature quantity extracting unit 38.

Finally, in step S105, the control unit 32 stores a result of the machine learning, and ends the process.

The control unit 32 repeats the process of steps S102 to S105 until it is determined in step S101 that there is no unprocessed project, and ends the process when there is no unprocessed project any more.

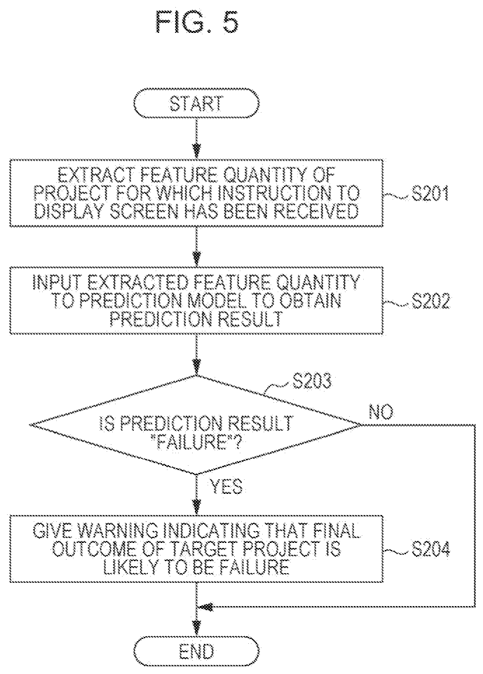

Next, an operation of performing a prediction process by the prediction model 34 generated in this manner will be described with reference to the flowchart in FIG. 5.

A description will be given of, for example, a case in which the control unit 32 receives an instruction to display a screen regarding a project from the terminal apparatus 20 of the superior via the data transmitting/receiving unit 31.

In this case, in step S201, the control unit 32 instructs the feature quantity extracting unit 38 to extract a current feature quantity of the project for which the instruction to display a screen has been received.

In step S202, the control unit 32 inputs the feature quantity extracted by the feature quantity extracting unit 38 to the prediction model 34, thereby obtaining a prediction result indicating whether the final outcome of the project is a success or a failure.

In step S203, the control unit 32 determines whether the prediction result is “failure”.

If it is determined in step S203 that the prediction result is “failure”, the control unit 32 displays, in step S204, a warning indicating that the final outcome of the target project is likely to be a failure on the screen.

If it is determined in step S203 that the prediction result is not “failure”, that is, the prediction result is “success”, the control unit 32 displays a screen regarding the target project as usual without giving any warning.

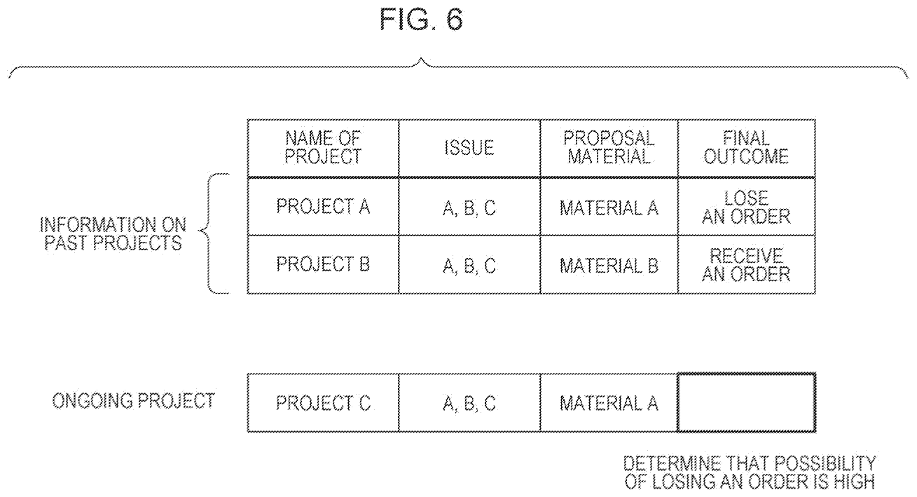

Next, a detailed description will be given of a prediction example in which the prediction model 34 predicts a final outcome from a feature quantity of a project, with reference to FIG. 6.

For example, it is assumed that the prediction model 34 has been subjected to machine learning regarding projects A and B as information on past projects.

Here, it is assumed that project A is in the following situation.
(1) In project A, issues A, B, and C are raised through a hearing with the client.
(2) An explanation is given to the client using proposal material A.
(3) The final outcome of project A is “lose an order”.

It is assumed that project B is in the following situation.
(1) In project B, issues A, B, and C are raised through a hearing with the client.
(2) An explanation is given to the client using proposal material B.
(3) The final outcome of project B is “receive an order”.

As a result of performing machine learning of the prediction model 34 on the basis of such information on past projects, the prediction model 34 learns that a set of issues A, B, and C and proposal material A is highly likely to cause a final outcome “lose an order” in a project. The prediction model 34 also learns that a set of issues A, B, and C and proposal material B is highly likely to cause a final outcome “receive an order” in a project.

In project C that is ongoing, issues A, B, and C are raised through a hearing with the client. A description will be given of a case in which an explanation using proposal material A is given to the client in project C.

In this case, as a result of inputting a feature quantity extracted from information regarding project C to the prediction model 34, a prediction result indicating that a final outcome is highly likely to be “lose an order” is output. Thus, the control unit 32 displays the prediction result indicating that a final outcome is highly likely to be “lose an order” when displaying the management screen of project C.

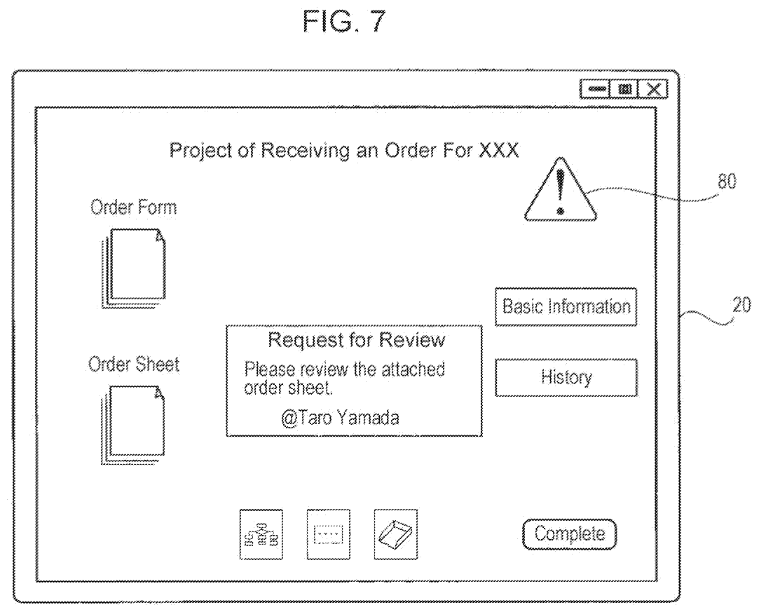

FIG. 7 illustrates an example of a display screen displayed by the control unit 32 on the screen of the terminal apparatus 20 of the superior. As illustrated in FIG. 7, a warning 80 is displayed on the management screen of project C.

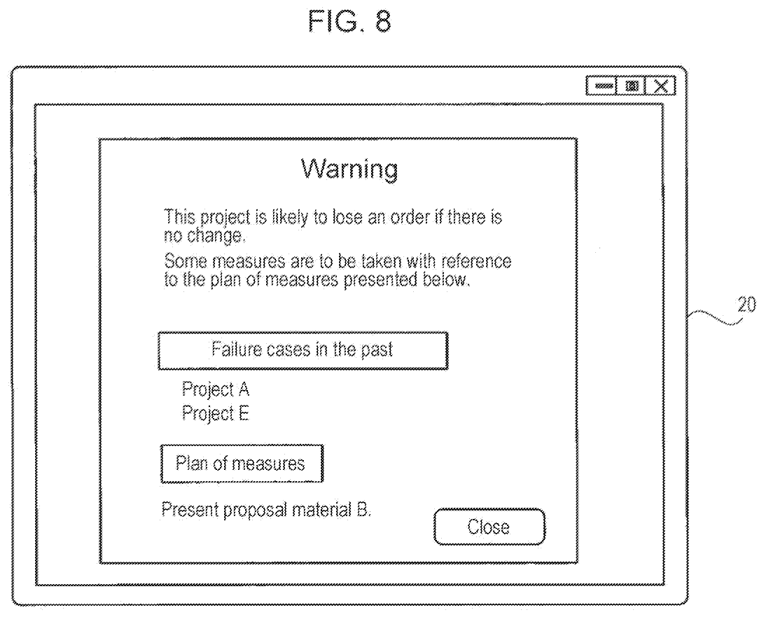

FIG. 8 illustrates an example of a warning screen that is displayed by operating the warning 80. In FIG. 8, a message is displayed indicating that a final outcome is highly likely to be “lose an order” if this project is implemented in a current status. Past projects having a final outcome “lose an order” are also displayed as failure cases, and the display of “project A” and so forth is link information for displaying a failure case. A user viewing the display clicks the link information, thereby being able to know the details of other projects listed as failure cases.

The warning screen illustrated in FIG. 8 shows a plan of measures to lead this project to a success. Specifically, a plan of measures “present proposal material B” is shown.

The superior viewing the plan of measures instructs a salesperson to present proposal material B to the client, and thereby a possibility that a final outcome of project C is “receive an order” increases.

Next, a specific operation for obtaining such a plan of measures will be described below.

The control unit 32 performs machine learning of the learning model 33, so as to obtain a plan of measures to be proposed for a project whose final outcome is likely to be “lose an order”.

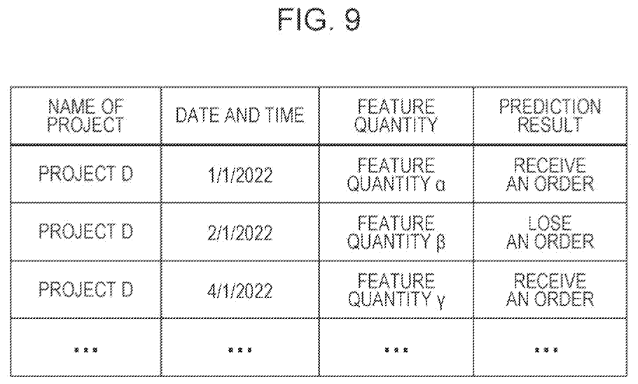

For this purpose, the control unit 32 stores in the feature quantity storage unit 35, in time series, a feature quantity extracted from a past project, a date and time on which the feature quantity is extracted, and information on a prediction result based on the feature quantity. An example of the data stored in the feature quantity storage unit 35 in this manner is illustrated in FIG. 9.

For example, the data example illustrated in FIG. 9 shows a feature quantity α extracted on Jan. 1, 2022 and shows that the prediction result obtained by inputting the feature quantity α to the prediction model 34 is “receive an order”, regarding project D in the past.

In addition, the data example illustrated in FIG. 9 shows a feature quantity β extracted on Feb. 1, 2022 and shows that the prediction result obtained by inputting the feature quantity β to the prediction model 34 is “lose an order”, regarding project D in the past.

Furthermore, the data example illustrated in FIG. 9 shows a feature quantity γ extracted on Apr. 1, 2022 and shows that the prediction result obtained by inputting the feature quantity γ to the prediction model 34 is “receive an order”, regarding project D in the past.

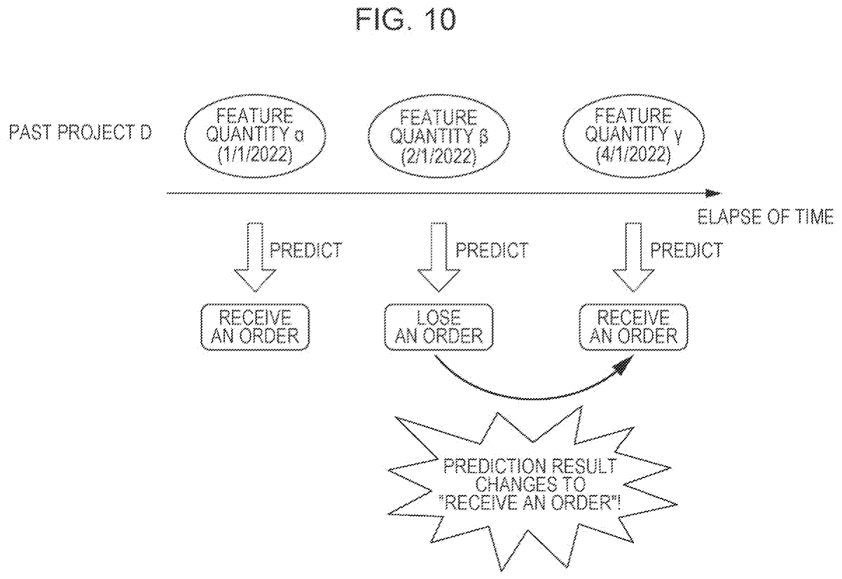

FIG. 10 illustrates changes with time of the prediction result of project D. As illustrated in FIG. 10, although the prediction result based on the feature quantity β extracted on Feb. 1, 2022 is “lose an order”, the prediction result based on the feature quantity γ extracted on Apr. 1, 2022 is “receive an order”.

Thus, the control unit 32 obtains, from the project management DB 36 and the communication information DB 37, measures carried out in project D during a period from Feb. 1, 2022 to Apr. 1, 2022.

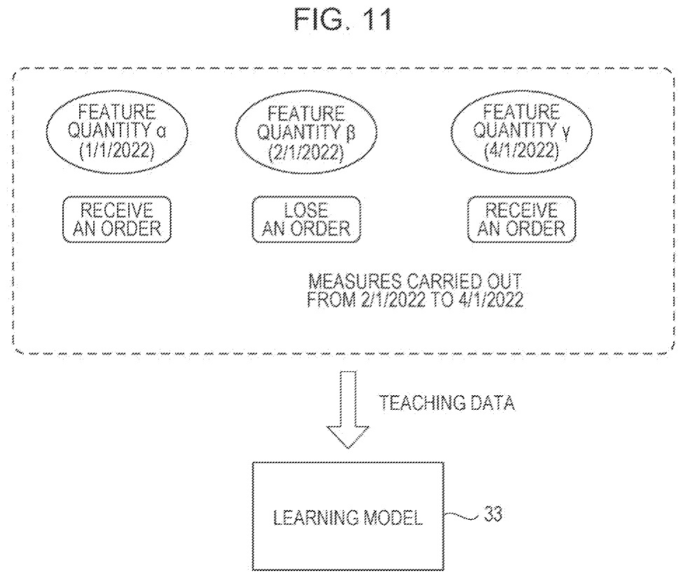

The control unit 32 then executes machine learning of the learning model 33 by using, as teaching data, the obtained measures and information on feature quantities α, β, and γ, the prediction results, and the date and time on which the feature quantities are extracted, as illustrated in FIG. 11.

As a result of such machine learning, the learning model 33 outputs, in response to receipt of a feature quantity obtained when a prediction result of failure is obtained, a plan of additional measures for changing the prediction result from a failure to a success.

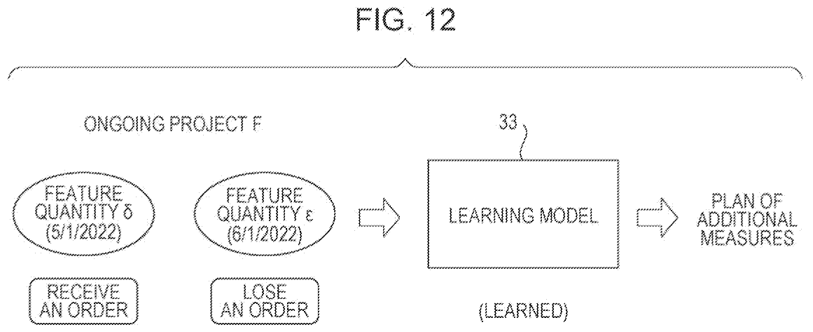

FIG. 12 illustrates an example of an operation of obtaining a plan of additional measures by using the learning model 33.

Referring to FIG. 12, in project F that is ongoing, a prediction result obtained by inputting a feature quantity δ extracted on May 1, 2022 to the prediction model 34 is “receive an order”. However, a prediction result obtained by inputting a feature quantity δ extracted on Jun. 1, 2022 to the prediction model 34 is “lose an order”.

The control unit 32 inputs, to the learning model 33, the feature quantity δ extracted on May 1, 2022 and information indicating that the obtained prediction result is “receive an order”, and the feature quantity ε extracted on Jun. 1, 2022 and information indicating that the obtained prediction result is “lose an order”.

Accordingly, the learning model 33 outputs a plan of additional measures to obtain a final outcome “receive an order” of project F, and the control unit 32 is capable of obtaining the plan of additional measures to be proposed on the warning screen.

The control unit 32 then displays the obtained plan of additional measures on the warning screen illustrated in FIG. 8, and thereby a user given the warning is able to acquire information on the plan of additional measures.

In the embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### (Appendix)

(((1)))

An information processing apparatus comprising:
a processor configured to:
   extract a feature quantity regarding one or more ongoing projects;
   input the feature quantity extracted from the one or more ongoing projects to a prediction model, to predict a project that is to have a final outcome of failure among the one or more ongoing projects, the prediction model having been subjected to machine learning using, as teaching data, a feature quantity of a past project having a final outcome of failure and the final outcome of failure; and
   give a warning for the project predicted to have a final outcome of failure.
      (((2)))

The information processing apparatus according to (((1))), wherein the processor is configured to perform the machine learning of the prediction model using, as the teaching data, not only the feature quantity of the past project having the final outcome of failure but also a feature quantity of a past project having a final outcome of success and the final outcome of success.

(((3)))

The information processing apparatus according to (((1))) or (((2))), further comprising a memory, wherein:
the processor is configured to:
   store in the memory, in time series, measures taken to implement a project, a prediction result of the prediction model for the project that is ongoing, and a feature quantity of the project obtained when the prediction result is obtained;
   in a case where the prediction result stored in the memory changes from failure to success, obtain a feature quantity obtained when the prediction result of failure is obtained and measures taken while the prediction result changes from failure to success;
   input, to a learning model, a feature quantity extracted from the ongoing project for which the warning indicating that a final outcome is predicted to be failure has been given, to obtain a plan of additional measures for the ongoing project for which the warning has been given, the learning model having been subjected to machine learning using, as teaching data, the feature quantity obtained when the prediction result of failure is obtained and the measures taken while the prediction result changes from failure to success; and
   present the obtained plan of additional measures together with the warning for the project predicted to have a final outcome of failure.
      (((4)))

The information processing apparatus according to (((3))), wherein the processor is configured to perform the machine learning of the learning model using, as the teaching data, not only the feature quantity obtained when the prediction result of failure is obtained but also a feature quantity obtained when a prediction result of success is obtained before a date and time on which the prediction result of failure is obtained.

(((5)))

The information processing apparatus according to any one of (((1))) to (((4))), wherein the processor is configured to extract, as a feature quantity regarding a project, at least one of information on measures taken to implement the project, information on an action performed by a user to implement the project, information on a medium that has been used, information on a user participating in the project, or information on business support software that is being used.

(((6)))

The information processing apparatus according to (((5))), wherein the processor is configured to obtain, from message information transmitted and received in the business support software for performing communication between a plurality of users, the information on measures taken to implement the project, the information on an action performed by a user to implement the project, or the information on a medium that has been used.

(((7)))

The information processing apparatus according to any one of (((1))) to (((6))), wherein the processor is configured to determine, based on a condition set in advance, whether a project completed in a past is a failure or a success.

(((8)))

A program causing a computer to execute a process, the process comprising:
extracting a feature quantity regarding one or more ongoing projects;
inputting the feature quantity extracted from the one or more ongoing projects to a prediction model, to predict a project that is to have a final outcome of failure among the one or more ongoing projects, the prediction model having been subjected to machine learning using, as teaching data, a feature quantity of a past project having a final outcome of failure and the final outcome of failure; and
giving a warning for the project predicted to have a final outcome of failure.

What is claimed is:

1. An information processing apparatus comprising:
a processor configured to:
extract a feature quantity regarding one or more ongoing projects;
input the feature quantity extracted from the one or more ongoing projects to a prediction model, to predict a project that is to have a final outcome of failure among the one or more ongoing projects, the prediction model having been subjected to machine learning using, as teaching data, a feature quantity of a past project having a final outcome of failure and the final outcome of failure; and
give a warning for the project predicted to have a final outcome of failure.

2. The information processing apparatus according to claim 1, wherein the processor is configured to perform the machine learning of the prediction model using, as the teaching data, not only the feature quantity of the past project having the final outcome of failure but also a feature quantity of a past project having a final outcome of success and the final outcome of success.

3. The information processing apparatus according to claim 1, further comprising a memory, wherein:
the processor is configured to:
store in the memory, in time series, measures taken to implement a project, a prediction result of the prediction model for the project that is ongoing, and a feature quantity of the project obtained when the prediction result is obtained;
in a case where the prediction result stored in the memory changes from failure to success, obtain a feature quantity obtained when the prediction result of failure is obtained and measures taken while the prediction result changes from failure to success;
input, to a learning model, a feature quantity extracted from the ongoing project for which the warning indicating that a final outcome is predicted to be failure has been given, to obtain a plan of additional measures for the ongoing project for which the warning has been given, the learning model having been subjected to machine learning using, as teaching data, the feature quantity obtained when the prediction result of failure is obtained and the measures taken while the prediction result changes from failure to success; and
present the obtained plan of additional measures together with the warning for the project predicted to have a final outcome of failure.

4. The information processing apparatus according to claim 3, wherein the processor is configured to perform the machine learning of the learning model using, as the teaching data, not only the feature quantity obtained when the prediction result of failure is obtained but also a feature quantity obtained when a prediction result of success is obtained before a date and time on which the prediction result of failure is obtained.

5. The information processing apparatus according to claim 1, wherein the processor is configured to extract, as a feature quantity regarding a project, at least one of information on measures taken to implement the project, information on an action performed by a user to implement the project, information on a medium that has been used, information on a user participating in the project, or information on business support software that is being used.

6. The information processing apparatus according to claim 5, wherein the processor is configured to obtain, from message information transmitted and received in the business support software for performing communication between a plurality of users, the information on measures taken to implement the project, the information on an action performed by a user to implement the project, or the information on a medium that has been used.

7. The information processing apparatus according to claim 1, wherein the processor is configured to determine, based on a condition set in advance, whether a project completed in a past is a failure or a success.

8. A non-transitory computer readable medium storing a program causing a computer to execute a process, the process comprising:
extracting a feature quantity regarding one or more ongoing projects;
inputting the feature quantity extracted from the one or more ongoing projects to a prediction model, to predict a project that is to have a final outcome of failure among the one or more ongoing projects, the prediction model having been subjected to machine learning using, as teaching data, a feature quantity of a past project having a final outcome of failure and the final outcome of failure; and
giving a warning for the project predicted to have a final outcome of failure.

9. An information processing method comprising:
extracting a feature quantity regarding one or more ongoing projects;
inputting the feature quantity extracted from the one or more ongoing projects to a prediction model, to predict a project that is to have a final outcome of failure among the one or more ongoing projects, the prediction model having been subjected to machine learning using, as teaching data, a feature quantity of a past project having a final outcome of failure and the final outcome of failure; and
giving a warning for the project predicted to have a final outcome of failure.
